(19) United States
(12) Patent Application Publication
(10) Pub. No.: US 2010/0223258 A1
(43) Pub. Date: Sep. 2, 2010

(54) INFORMATION RETRIEVAL SYSTEM AND METHOD USING A BAYESIAN ALGORITHM BASED ON PROBABILISTIC SIMILARITY SCORES

(75) Inventors: Zoubin Ghahramani, Cambridge (GB); Katherine Anne Heller, London (GB)

Correspondence Address: BROOKS KUSHMAN P.C., 1000 TOWN CENTER, TWENTY-SECOND FLOOR, SOUTHFIELD, MI, 48075, US

(73) Assignee: UCL BUSINESS PLC, London (GB)

(21) Appl. No.: 12/095,637

(22) PCT Filed: Dec. 1, 2006
(86) PCT No.: PCT/GB06/04504

§ 371 Date: Apr. 8, 2010

(30) Foreign Application Priority Data
Dec. 1, 2005 (GB) 0524572.5

(51) Int. Cl. G06F 17/30

(52) U.S. Cl. 707/723; 707/E17.014; 707/769

(57) ABSTRACT

An algorithm is provided which uses a model-based concept of a cluster and scores items using a score representative of the probability that a given item has been generated from the same distribution as one or more query items. The items are represented by a feature vector xᵢ comprising a plurality of digitally represented features xᵢⱼ the method including: receiving an input identifying the query items; for each of the other items computing a score which is a function of a conditional probability of the feature vectors xᵢⱼ of the query items being generated from the generating distribution formula (I) given that the respective other item is generated from the generating distribution formula (I) and returning a score for each of the other items, a list of some or all of the other items, sorted by their respective score, or a list of n other items which have the highest score.

The present invention relates to scoring of similarity between items, in particular although not exclusively in the field of information retrieval and more particularly to example-based retrieval of related items.

Typically, known methods of information retrieval are concerned with finding those documents in a collection of documents which are found to be relevant to a query under some criteria. The query typically consists of a list of words—typical examples are a web search or a search in a database of patent documents.

Information retrieval (IR) methods which rely on a probalistic criterion to determine the relevance of documents are known in the prior art. These methods ask the question “what is the probability that this document is relevant to this query?”. There are two main approaches to this question (as discussed in John Lafferty and Chengxiang Zhai (2003) Probabilistic relevance models based on document and query information. In Language Modelling Information Retrieval, Kluwer International Series on Information Retrieval, Vol. 13, herewith incorporated herein by reference.):

1) two models are estimated for each query, one modelling relevant documents, the other modelling non-relevant documents and documents are ranked according to the posterior probability of relevance or;
2) a language model is estimated for each document, and the operational procedure for ranking is to order documents by the probability assigned to the query according to the model of each document.

Notably, both approaches require estimating parameters for a number of statistical models.

One problem encountered when searching a text query in a database is that a query will return a large number of documents which contain hits for the words in the query. These may or may not be relevant to what the user had actually in mind because a query may produce hits in a number of conceptual clusters in the database, only one of which was intended by the user. A solution to this problem is proposed in, for example, U.S. Pat. No. 6,385,602, herewith incorporated herein by reference where such results are presented using dynamic categorization. This is based upon attributes of the search results and uses any suitable grouping or clustering technique. The search results are then presented in categories designed to help the user to select the one he was looking for. However, as the categories are generated by clustering algorithms which are typically unsupervised, the categories may not correspond to what the user actually had in mind.

Google™ Sets, herewith incorporated herein by reference is an experimental tool provided by Google™ which automatically creates sets of items from a few examples. The user enters a few items from a set of things and the interface tries to predict other items in the set. Given a query, consisting of a small set of items, the algorithm returns a larger set of relevant items which belong to the set (referred to as a cluster herein below) defined by the query. For example, given three brands of cars, the interface will return an expanded set containing additional brands of cars. The user can then click on any of the items in the expanded set to perform a web search on that item. However, the resulting search capability is limited to performing a web search for any one of the retrieved items of the expanded set.

Traditional text-based IR queries are based on keywords combined by logical operators. It would be advantageous to provide a search tool or general application which includes as a further operator a similarity operator in the sense that it retrieves items which belong to the same conceptual cluster as the items in the query. This would provide a powerful search mechanism in which the query itself defines the cluster from which the results are found. In other words, such a query is based on a similarity score which is related to how well the items of the query and the returned items fit the same conceptual cluster.

In a first aspect of the invention, there is provided a computer implemented method of scoring similarity between query and other items as defined in claim 1.

Advantageously, the score assigned to items depends on the probability that the query items and the other items are generated from the same generating distribution or statistical model. In the field of audio coding and speech recognition it has long been established that, respectively, better decompression and recognition can be achieved if one takes account of the way the human auditory system works. Recent experimental evidence has suggested that people judge items which are generated from the same statistical distribution to be more similar than items generated using other protocols suggested in the psychological literature (A generative theory of similarity. Kemp, C., Bernstein, A., and Tenenbaum, J. B. (2005). Proceedings of the Twenty-Seventh Annual Conference of the Cognitive Science Society, herewith incorporated herein by reference). In a similar spirit to the reasoning in audio coding or speech recognition, the similarity score of the present invention is inspired by psychological evidence of how people judge similarity.

Preferably, the generating distribution is defined by a number of parameters and, rather than estimating these parameters from data (as in the probalistic IR literature quoted above), the score is averaged over all possible values of the parameters, thus avoiding issues relating to parameter estimation. This is often referred to as “marginalising out the parameters” or a fully Bayesian approach. Further psychological evidence (Generalization, similarity and Bayesian inference. J. B. Tenenbaum, T. L. Griffiths (2001), Behavioral and Brain Sciences, 24 pp. 629-641, herewith incorporated herein by reference) indicates that people generalise from experience and judge similarity by averaging over alternative hypothesis (corresponding to the parameter settings). Thus, the fully Bayesian approach to calculating the similarity scores may also be seen as well tuned to human cognition and perception of similarities.

The generating distribution may be a Bernoulli distribution and the parameters may be averaged under the corresponding conjugate prior, the Beta distribution. Advantageously, in the case of a Bernoulli distribution, the inventors have realised that, far from being computationally intense or even intractable the integrals involved can be efficiently implemented by a matrix multiplication.

In another aspect of the invention, there is provided a computer-implemented method of scoring the similarity between a query item and one or more items as defined in claim 5.

Advantageously, the method of scoring involves a matrix multiplication which implements a full Bayesian treatment of scoring similarity under a generative distribution if the items are represented by binary feature vectors. Thus the method implements all integrals involved in the computation of the score in a matrix operation.

Advantageously, the scoring method may be implemented even more efficiently if the representation of the items is sparse, which is typically the case. As used herein below, sparse means a representation in which a significant majority of entries is zero (or another constant), that is at least two thirds of the features are zero (or of a constant value). In particular for very large data sets, the items may be pre-processed such that only items which have at least a defined number of features in common with the query items are scored. This could be implemented, for example, using an inverse index.

The Beta distribution is characterised by two hyperparameters α and β. The parameters may be fit to the data by standard methods using Bayesian statistics, for example evidence maximisation or can be found using trial and error. One particular way of setting the hyperparemeters is to set the α parameter corresponding to each feature proportional to the average value of this feature over items and to set the β parameters corresponding to each feature as proportional to one minus the average. This is an efficient way of setting the hyperparameters such that the distribution of the parameters includes prior information over the structure of the data set and the hyperparameters can be fine tuned by tuning the constant of proportionality.

The items may be web pages, images, genes or proteins of known and unknown function, pharmacological molecules of known and unknown function, patient records or any other items of data such as words or movie titles.

It will be understood that the present invention is, at a physical level, quite independent of any particular kind of item or application. At a physical level, the items are simply groups of digital bits (which, depending on the application, represent different real-world things) and the present invention determines their similarity in the sense of the probability that the groups of bits were generated by the same random process. The detailed algorithm is determined by the statistical model chosen for this random process (e.g. independent Bernoulli trials) but not by the meaning associated with the groups of bits or items.

Advantageously, by selecting a subset of search results of a preliminary search query, the query may be refined to items which are likely to belong to the same conceptual cluster as the selected search results.

Advantageously, the method may provide for image searches using keywords by labelling a subset of images with predefined keywords. The results of the keyword search may then be used as an input to a similarity search as set out above. In this way, images from a large, unlabelled set of images can be retrieved by first searching a small, labelled set of example images. The method may further be used for cleaning up or annotating data sets.

According to further aspects of the invention, there is provided a computer system as claimed in claim 21, a computer program as described in claim 22 and a computer readable medium and data signal as described in claims 23 and 24.

Yet further aspects of the invention extend to use methods of searching images, cleaning up data sets and labelling an item as in claims 25, 26 and 27, respectively.

Specific embodiments of the invention are now described by way of example only and with reference to the accompanying drawings in which:

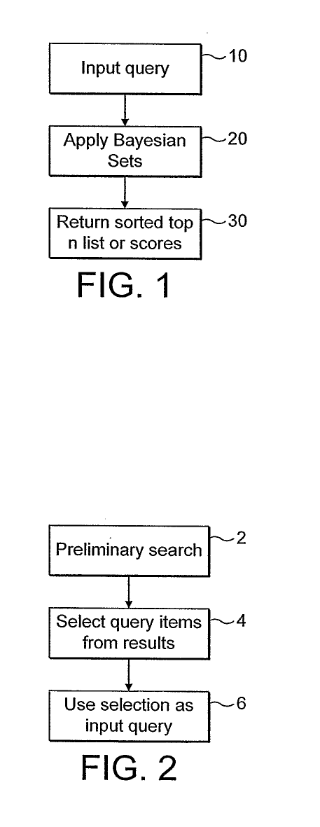

FIG. 1 depicts a flow diagram of an embodiment of the invention; and

FIG. 2 depicts a flow diagram of a method of inputting a query to the embodiment of FIG. 1;

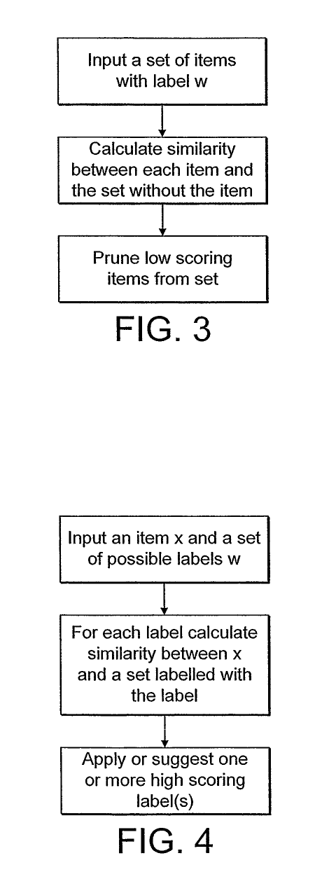

FIG. 3 depicts a flow diagram of a method of cleaning up data sets; and

FIG. 4 depict a flow diagram of a method of annotating items.

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description which follow are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

### Overview

Consider a universe of items D. Depending on the application, the set D may consist of web pages, movies, people, words, proteins, images, or any other object one may wish to form queries on. A user provides a query in the form of a subset of items D_{c}⊂D. The assumption is that the elements in D_{c} are examples of some concept, class or cluster in the data (from here on, the term “cluster” is used). The algorithm then has to provide a completion to the set D_{c}—that is, some set D′_{c}⊂D which includes all the elements in D_{c} and other elements in D which are also in the same cluster.

One can think of the goal of the algorithm to be to solve a particular information retrieval problem. As in other retrieval problems, the output should be relevant to the query, and one possibility is to limit the output to the top few items ranked by relevance to the query.

### Bayesian Sets

The algorithm described below will be referred to as “Bayesian sets” in the remainder for ease of reference.

Let D be a data set of items, and xεD be an item from this set. Assume the user provides a query set D_{c} which is a small subset of D. The goal is to rank the elements of D by how well they would “fit into” a set which includes D_{c}. Intuitively, the task is clear: if the set D is the set of all movies, and the query set consists of two animated Disney movies, we expect other animated Disney movies to be ranked highly.

Assuming D_{c} to belong to some cluster, we want to know how probable it is that x also belongs with D_{c}. This is measured by p(x|D_{c}), the probability of x belonging to the cluster given that D_{c} does. Ranking items simply by this probability may not be sensible since some items may be more probable than others, regardless of D_{c}. For example, under most sensible models, the probability of a string decreases with the number of characters, the probability of an image decreases with the number of pixels, and the probability of any continuous variable decreases with the precision to which it is measured. To remove these effects, one computes the ratio

$$score ( x ) = \frac{p ( x \vert {D}_{c} )}{p ( x )} \qquad ( 1 )$$

where the denominator is the prior probability of x.

Using Bayes rule, this score can be re-written as

$$score ( x ) = \frac{p ( x , {D}_{c} )}{p ( x ) p ( {D}_{c} )} \qquad ( 2 )$$

which can be interpreted as the ratio of the joint probability of observing x and D_{c}, as belonging to the same cluster, to the probability of x and D_{c}. Finally, up to a multiplicative constant independent of x, the score can be written as:

score(x)=p(D_{c}|x) (3)

which is the probability of the query set belonging to a cluster given that x does (i.e. the likelihood of x).

The above discussion, does not address how one would compute quantities such as p(x|D_{c}) and p(x). A model-based way of defining a cluster is to assume that the data points in the cluster all come independently and identically distributed from a parameterized statistical model or distribution. Assume that the parameterized model is p(x|θ) where θ are the parameters. If the data points in D_{c} all belong to one cluster, then under this definition they were generated from the same setting of the parameters; however, that setting is unknown.

One possible solution is to estimate the parameters from the query itself, which may be problematic for small queries. A more principled approach which does not rely on parameter estimation is to use a fully Bayesian approach, that is to average over possible parameter values weighted by a prior density on or distribution over parameter values, p(θ). Using these considerations and the basic rules of probability we arrive at:

$$\begin{matrix}p ( x ) = \int p ( x \vert θ ) p ( θ ) d θ & ( 4 ) \\ p ( {D}_{c} ) = \int p ( {D}_{c} \vert θ ) p ( θ ) d θ & ( 5 a ) \\ p ( {D}_{c} \vert θ ) = {\prod }_{{x}_{l} ∈ {D}_{c}} p ( {x}_{i} \vert θ ) & ( 5 b ) \\ p ( x \vert {D}_{c} ) = \int p ( x \vert θ ) p ( θ \vert {D}_{c} ) d θ & ( 6 ) \\ p ( θ \vert {D}_{c} ) = \frac{p ( {D}_{c} \vert θ ) p ( θ )}{p ( {D}_{c} )} & ( 7 )\end{matrix}$$

Equipped with these equations, a Bayesian sets algorithm can be described as follows, computing the score for all items or for all items {xᵢ} [symbol] D_{c}, for example:

Bayesian Sets Algorithm
background: a set of items D, a probabilistic
model p(x | θ) where x ∈ D, a prior on the model
parameters p(θ)
input: a query D_{c} = {xₖ} ⊂ D
for all xᵢ ∈ D to be scored do

$compute score ( {x}_{i} ) = \frac{p ( {x}_{i} \vert {D}_{c} )}{p ( {x}_{i} )}$

end for
output: return elements of D sorted by decreasing
score

It will be recalled from equation (3) that, up to a multiplicative constant independent of the query, the above score can be expressed as the conditional probability of the feature vectors xᵢ of the query items given the feature vector xᵢ of the respective other items of the set. Thinking of the feature vectors as being generated from an underlying parametrised distribution, the score may be seen as a function of the conditional probability of the feature vectors xᵢ of the query items being generated from the generating distribution p(xᵢ|θ) defined by parameters θ given that the respective feature vectors xᵢ of the respective other items is generated from the generating distribution p(xᵢ|θ).

There are typically two common concerns with fully Bayesian methods, that is tractability and sensitivity to priors. In the present embodiments, the inventors have realised that a fully Bayesian treatment can be implemented in a way which is both analytical and computationally efficient and not overly sensitive to the choice of prior distributions:

1. For many models, the integrals (4)-(6) are analytical. In fact, for the model we consider below for binary data, the inventors have found that computing all the scores can be reduced to a single matrix multiplication.
2. Although it is clearly advantageous to choose sensible models p(x|θ) and priors p(θ), these need not be complicated. The results presented below illustrate that simple models and almost no tuning of the prior can result in competitive retrieval results. In practice, a simple empirical heuristic which sets the prior to be vague but centered on the mean of the data in D can be used.

### Binary Data

The Bayesian Sets algorithm outlined above finds particular although not exclusive application for sparse binary data. This type of data is a natural representation for large datasets characterised by the presence or absence of features for each item.

Assume each item xᵢεD is a binary vector xᵢ=(xᵢ₁, . . . , xᵢⱼ) where xᵢⱼε{0,1}, and that each element of xᵢ has an independent Bernoulli distribution:

$$p ( {x}_{i} \vert θ ) = {\prod }_{j = 1}^{J} {{θ}_{j}^{{x}_{ij}} ( 1 - {θ}_{j} )}^{1 - {x}_{ij}} \qquad ( 8 )$$

The conjugate prior for the parameters of a Bernoulli distribution is the Beta distribution:

$$p ( θ \vert α , β ) = {\prod }_{j = 1}^{J} \frac{Γ ( {α}_{j} + {β}_{j} )}{Γ ( {α}_{j} ) Γ ( {β}_{j} )} {{θ}_{j}^{{α}_{j} - 1} ( 1 - {θ}_{j} )}^{{β}_{j} - 1} \qquad ( 9 )$$

where α and β are hyperparameters of the prior, and the Gamma function is a generalization of the factorial function. For a query D_{c}={xₖ} consisting of N vectors it is easy to show that:

$$p ( {D}_{c} \vert α , β ) = {\prod }_{j} \frac{Γ ( {α}_{j} + {β}_{j} ) Γ ( {\tilde{α}}_{j} ) Γ ( {\tilde{β}}_{j} )}{Γ ( {α}_{j} ) Γ ( {β}_{j} ) Γ ( {\tilde{a}}_{j} + {\tilde{β}}_{j} )} \qquad ( 10 )$$

where \tilde{α}ⱼ=αⱼ+Σₖ₌₁^{N} xₖⱼ and \tilde{β}ⱼ=βⱼ+N−Σₖ₌₁^{N} xₖⱼ. For an item xᵢ=(xᵢ₁ . . . xᵢⱼ) the score, written with the hyperparameters explicit, can be computed as follows:

$$\begin{matrix}score ( {x}_{i} ) = \frac{p ( {x}_{i} \vert {D}_{c} , α , β )}{p ( {x}_{i} \vert α , β )} \\ = {\prod }_{j} \frac{\frac{Γ ( {α}_{j} + {β}_{j} + N )}{Γ ( {α}_{j} + {β}_{j} + N + 1 )} \frac{Γ ( {\tilde{α}}_{j} + {x}_{ij} ) Γ ( {\tilde{β}}_{j} + 1 - {x}_{ij} )}{Γ ( {\tilde{α}}_{j} ) Γ ( {\tilde{β}}_{j} )}}{\frac{Γ ( {α}_{j} + {β}_{j} )}{Γ ( {α}_{j} + {β}_{j} + 1 )} \frac{Γ ( {\tilde{α}}_{j} + {x}_{ij} ) Γ ( {β}_{j} + 1 - {x}_{ij} )}{Γ ( {α}_{j} ) Γ ( {β}_{j} )}}\end{matrix} \qquad ( 11 )$$

This daunting expression can be dramatically simplified. We use the fact that Γ(x)=(x−1)Γ(x−1) for x>1. For each j we can consider the two cases xᵢⱼ=0 andxᵢⱼ=1 separately. For xᵢⱼ=1 we have a contribution

$$\frac{{α}_{j} + {β}_{j}}{{α}_{j} + {β}_{j} + N} \frac{{\tilde{α}}_{j}}{{α}_{j}} .$$

For xᵢⱼ=0 we have a contribution

$$\frac{{α}_{j} + {β}_{j}}{{α}_{j} + {β}_{j} + N} \frac{{\tilde{β}}_{j}}{{β}_{j}} .$$

Putting these together we get:

$$score ( {x}_{i} ) = {\prod }_{j} \frac{{α}_{j} + {β}_{j}}{{α}_{j} + {β}_{j} + N} {( \frac{{\tilde{α}}_{j}}{{α}_{j}} )}^{{x}_{ij}} {( \frac{{\tilde{β}}_{j}}{{β}_{j}} )}^{1 - {x}_{ij}} \qquad ( 12 )$$

The log of the score is linear in xᵢ:

$$\begin{matrix}log score ( {x}_{i} ) = c + {\sum }_{j} {q}_{j} {x}_{ij} \\ where & ( 13 ) \\ c = {\sum }_{j} log ( {α}_{j} + {β}_{j} ) - log ( {α}_{j} + {β}_{j} + N ) + log {\tilde{β}}_{j} - log {β}_{j} \\ and & ( 14 ) \\ {q}_{j} = log {\tilde{α}}_{j} - log {α}_{j} - log {\tilde{β}}_{j} + log {β}_{j} & ( 15 )\end{matrix}$$

If we put the entire data set D into one large matrix X with J columns and M rows, we can compute the vector s of log scores for all items using a single matrix vector multiplication of X and a query vector q:

s=c+Xq (16)

Each query D corresponds to computing the vector q. Adding c may be omitted, since this does not affect the ranking of scores. This can also be done efficiently (by pre-computing the expression) if the query is also sparse, since most elements of q will equal log βⱼ−log(βⱼ+N) which is independent of the query.

For sparse data sets, the matrix multiplication can be implemented very efficiently. Although we have defined sparse to mean two thirds or more of feature elements of the matrix X being zero, often the matrices will be much sparser than that (for example 1% of non-zero matrix elements). Where a sparse matrix has a structure such that over two thirds of entries are constant (as opposed to zero), the matrix can be transformed to a sparse matrix by subtracting the constant. Efficient algorithms use a sparse matrix data structure consisting of a list of (i, j, xᵢⱼ) for all indices (i,j) such that xᵢⱼ≠0 (e.g. the sparse matrix implementation in Matlab). Zero entries are not stored and do not take up any memory. The sparse matrix-vector multiplication loops over the non-zero elements, multiplying by the corresponding vector element and summing up. This algorithm is linear time in the number of non-zero elements of the matrix. See BLAS and LAPACK which are the basic linear algebra routines underlying Matlab™, and Sparse BLAS: http://www.netlib.org/sparse-blas/, herewith incorporated by reference herein.

For very large data sets (for example millions of entries) an Inverted Index (http://www.nist.gov/dads/HTML/invertedIndex.html, herewith incorporated herein by reference) can be used, which is a standard data structure used in information retrieval, e.g. for text documents on the web. This is a sparse representation of e.g. words (i.e. features) in a collection of documents (i.e. items), arranged so that each word or feature comes with a list of the documents it appears in. When doing retrieval, one then only needs to score the items which have some features in common with the query, rather than all items, making the algorithm even more efficient.

Finally, it is not necessary to sort all M items in the data set by their score, only to find the top few items for retrieval. Given a score vectors finding the top few items is O(M) and can be done more efficiently than sorting all items which is O(M log M). The algorithm requires looping once over M, updating the current list of top scoring items

The above algorithm requires a choice of hyperparameters (e.g. α and β) in order to define the prior distribution over parameters. While the hyperparemeters can be found using standard Bayesian techniques, such as evidence maximisation, a simple method which makes use of prior knowledge of the structure of matrix X can be used:
1) Compute the mean m over the data averaging the rows of X. The vector m is 1×J, there J is the number of columns of X.
2) Set αⱼ=const·mⱼ
3) Set βⱼ=const·(1−mⱼ)
   where const is a constant which can be determined by trial and error, or optimised using a Bayesian procedure based on the ‘evidence’. In the examples presented below const was set to const=2

Generally, the hyperparameters are set so that p(θ) gives a reasonable model of the data. In other words, generating from p(xᵢ) using those hyperparameters would result in rows of X with roughly the same statistics as the actual data.

The specific embodiment for binary data discussed above can be implemented in MATLAB™ along the following lines whereby details of input, output and preprocessing of the data have been omitted:

% X is the data set of all items, M rows, J columns:
% Y is the query, consisting of N rows (items) and J columns:
% setting up the priors:
const=2; % a constant, other values could work too
m=mean(X);
alpha=const * m;
beta=const *(1−m);
% setting up the query vector:
v=sum(Y);
alphat=alpha+v;
betat=beta+N−v;
% this is the q vector representing the query:
q=log(alphat)−log(alpha)−log(betat)+log(beta);
% this is the heart of the algorithm, a sparse matrix vector
% multiplication:
s=X*q;
% the constant of the above linear equation is omitted
% as it does not affect the ordering of the scores (the log
% probabilities)
% sort the scores in decreasing order:
[k,l]=sort(−s)
% l contains the indices of the top scoring items.
% return the top few (10 or 20) items from this list, e.g:
l(1:20)

### Applications

The Bayesian Sets algorithm described above can be applied to any situation where one needs to find members of an underlying conceptual cluster based on a query consisting of examples from this underlying conceptual cluster. Applications include, for example, finding words relating to similar concepts or movies sharing certain features. These examples will be discussed in relation to results presented below.

The algorithm may be applicable to many other applications, which are mainly distinguished by the representation used, that is by the features encoded by the binary values in the columns of the matrix X. In the various applications, the matrix X represents the following:
Websearch: each row represents a webpage and each column represents features of the webpages, for example words present in the metatags, webpages linked to, webpages which link to the page in question and/or whether certain keywords appear more frequently than a predetermined threshold in the webpage in question. By performing a keyword search for webpages, one could save relevant pages to a list and then query for all pages that are similar to all items in the list (see below).
Medical expert system: the rows represent patients and the columns represent features of the corresponding medical history, for example the presence or absence of certain conditions or symptoms and/or the value of certain physiological measurements being within a predetermined range of values. The range of values could distinguish between normal and pathological values but a more fine difference between value ranges is also envisaged. By presenting the system with feature vectors for patients suffering from a certain condition, one may be able to predict the likelihood of other individuals contracting a disease.
Gene/protein function analysis: rows represent genes or proteins, for example genes identified in the human genome and the columns represents genomic markers such as certain base sequences or the presence of certain sequences in certain positions in the gene. Similarly for proteins, columns represent structural or functional features of the proteins. A query could be formulated by selecting genes with a known function and using the Bayesian Sets similarly score to identify genes of unknown function as test candidates to verify whether they have the same or a similar function.
Drug discovery: rows represent molecules and columns represent the presence or absence of certain structural features or functional effects of the molecules. A query is based on selected pharmaceutical molecules which are known to have a desired function or curative effect. The returned highest scoring molecules can then be used as candidates for testing their activities.
Images: rows represent individual images and the columns represent binary features extracted from the images using standard image processing techniques. Since the binary features extracted by image processing from the image are unlikely to be meaningful to a user, a preliminary keyword search is also implemented as described in more detail below.
Thesaurus: rows represent words in a language and columns represent features of the words (see below). A query could be formulated with several words and may return alternatives relevant to the common meaning of all words in the query.
Searching tool for ecommerce: rows represent particular items available for purchase (e.g. property, digital camera, yacht, hotel stay, restaurant reservation, theatre tickets) and columns represent the features of the items (e.g. location, weight, price). By selecting items with desired properties, it may be possible to find other items with similar characteristics. Taking property as an example application, current searches rely on postcodes whereas specific roads or other locations are more pertinent to the buyer. The purchasers may specify a selection of properties from an initial search and find others that more closely meet their requirements.
Searching tool for human characteristics: rows represent an individual and columns represent key features of that individuals (e.g. their appearance as specified by a feature vector, their abilities, their interests). By selecting a few individuals with desired features, it may be possible to find other individuals who are similar. This may be used for on-line dating, finding actors, finding models, finding professionals in a particular industry, identifying potential criminals or other policing and homeland security initiatives.
Investment selection: rows represent investment instruments (e.g. equity, bond, derivative) and columns represent features of investment instruments, such as historical performance, sector, maturity. By selecting several example investment instruments, the system may present alternative similar instrument to the user.
Company search: rows represent companies and columns represent features of companies (e.g. industry, turnover, share-price). By selecting a set of companies, it may be possible to find similar companies. This would be useful for research, e.g. finding all the likely competitors for a company. It would also be useful in investment decision making processes.
Patent Search: rows represent individual patents or patent families and columns represent bibliographic data and/or patent content. If several patents are found that relate to a particular area, it may be possible to feed these into a search algorithm as described above and retrieve similar patents that cover the same area.
Recommender Systems: rows represent goods or services and columns their characteristics. It may be possible to suggest items to individuals that they may be interested in based on prior interests expressed, either through purchasing decisions (e.g. online book purchase history), searching decisions (e.g. a record of a search history), or expressed preferences (e.g. news, music, etc.). For example, the most recently searched or purchased items could be used as a query set for the Bayesian sets algorithm.
Customer Analysis: rows represent customers for a business and columns correspond to customer features (e.g. history of purchases, personal characteristics, tastes). By selecting a group of customers with desired characteristics, it may be possible to extrapolate to a wider set of similar customers. This would be useful, if for instance, a marketing campaign was run in one geographical location to upsell a product to existing customers (e.g. offering broadband internet access to dial-up internet customers). By marking the group of individuals who took up the promotion, the company could identify similar customers in a different geographical location and market only to them to reduce costs and increase likelihood of uptake.
Music Search: rows represent music pieces and columns represent their characteristics. By converting each piece of music to an appropriate feature vector, it may be possible to specify a selection of music to retrieve other music pieces with a similar feel, for example.
Finding sets of researchers who work on similar topics based on their publications. The space of authors (of literary works, scientific papers, or web pages) can be searched in order to discover groups of people who have written on similar themes, worked in related research areas, or share common interests or hobbies.
Searching scientific literature for clusters of similar papers: instead of providing keywords, one can search by example using Bayesian Sets: a small set of relevant papers can capture the subject matter in a much richer way than a few keywords
Searching a protein database Using the Bayesian retrieval method herein described, an entirely novel approach to searching UniProt (Universal Protein Resource), the “world's most comprehensive catalog of information on proteins” has been created [http://www.uniprot.org]. Each protein is represented by a feature vector derived from GO (Gene Ontology) annotations, PDB (Protein Data Bank) structural information, keyword annotations, and primary sequence information. The user can query the database by giving the names of a few proteins, which for example she knows share some biological properties, and the system will return a list of other proteins which, based on their features, are deemed likely to share these biological properties. Since the features include annotations, sequence, and structure information, the matches returned by the system incorporate vastly more information than that of a typical text query, and can therefore tease out more complex relationships. For example, querying Uniprot based on two hypothetical proteins exhibiting yeast like characteristics, our system naturally generalizes to retrieve other proteins fitting the category “CYS3 YEAST”; finding such matches using traditional keyword-based approaches would be very difficult.

With reference to FIG. 1, an implementation of the Bayesian Sets algorithm takes one or more query item as an input at step 10 and applies the Bayesian Sets algorithm to calculate a score for each item (possibly including the items of the input query) at step 20. At step 30 the algorithm either returns a, preferably sorted, top n (for example n=10) list of items having the n highest scores or returns the scores itself either for display to the user or for use by other algorithms.

With reference to FIG. 2, a conventional type of search, for example a keyword search or any other suitable kind of search is first carried out in order to return a list of search results to the users at step 2. The user then selects one or more promising search results and the selection is captured at step 4. The selected search results are then used as an input query at step 6 and the algorithm follows on at step 10 of FIG. 1 in order to refine the search by scoring all search results according to the Bayesian Sets algorithm as described above.

For example, in one particular implementation a web search interface provides a conventional keyword search that additionally provides in a selection box adjacent to each search result. A user can then select promising search results and interact with the web page in order to submit these results either to an applet residing on the users computer or to a web server in order to refine the query in accordance with the Bayesian Sets algorithm described above and with reference to FIG. 1.

As set out above, special considerations apply when searching images, since the proposed set of binary features may not be meaningful to a user. To overcome this potential difficulty, a subset of the images are labelled with a set of words associated with the respective images. A situation is envisaged where there exists a large unlabelled data set of images (for example obtained from the worldwide web) which are not yet associated with words but for which binary features as set out above have been defined.

In a first step corresponding to step 2 of FIG. 2, the user enters a text query for example “pink rose” and the algorithm finds the set of all images in the labelled data set which have those word labels as a preliminary search. The search result of this query can then be used as an input query (step 10) for the Bayesian Set algorithm which may then, for example, return the highest ten ranking images from the large, unlabelled database. Of course, this may be combined with steps 4 and 6 of FIG. 2 in that a user may select a subset of the images returned by the text query as an input query to the Bayesian Sets algorithms.

The feature vectors of an image may be defined, for example, using two types of texture features, for example, 48 Gabor texture features and 27 Tamura texture features, and, for example, 165 color histogram features, for example. Coarseness, contrast and directionality Tamura features are computed, as in H. Tamura, S. Mori, and T. Yamawaki (Textual features corresponding to visual perception. IEEE Trans on Systems, Man and Cybernetics, 8:460-472, 1978), herewith incorporated herein by reference, for each of 9 (3×3) tiles. Six scale sensitive and four orientation sensitive Gabor filters may be applied to each image point, computing the mean and standard deviation of the resulting distribution of filter responses. See P. Howarth and S. Rüger (Evaluation of texture features for content-based image retrieval. In International Conference on Image and Video Retrieval (CIVR), 2004), herewith incorporated herein by reference, for more details on computing these texture features. For the color features an HSV (Hue Saturation Value) 3D histogram (see D. Heesch, M. Pickering, S. Rüger, and A. Yavlinsky. Video retrieval with a browsing framework using key frames. In Proceedings of TRECVID, 2003.2, herewith incorporated herein by reference) such that there are eight bins for hue and five each for value and saturation is computed. The lowest value bin is typically not partitioned into hues since they are not easy for people to distinguish.

The feature vectors calculated in this way are real-valued. After the 240 dimensional feature vector is computed for each image, the feature vectors for all images in the data set may be preprocessed together. The purpose of this preprocessing stage is to binarize the data in an informative way. First the skewness of each feature is calculated across the data set. If a specific feature is positively skewed, the images for which the value of that feature is above the 100-pth percentile, e.g. the 80^{th} percentile, assign the value ‘1’ to that feature, the rest assign the value ‘0’ to that feature. If the feature is negatively skewed, the images for which the value of that feature is below the pth percentile, e.g. the 20th percentile, assign the value ‘1’, and the rest assign the value ‘0’. This preprocessing turns the entire image data set into a sparse binary matrix, which focuses on the features which most distinguishes each image from the rest of the data set.

It is understood that p can be set to different values, for example for different data sets, and that the upper and lower values of p need not be the same, i.e. one could have 100-p1 for positively skewed data and p2 for negatively skewed data. Moreover, the approach of binarizing real-valued feature vectors, as described above, is not limited to image data but can be applied to any real-valued data contained in the feature vector. In order to obtain sparse data, the percentile threshold should be larger than 50%, preferably larger than 70%, for positively skewed data. Similarly, the percentile threshold should be below 50%, preferably below 30%, for negatively skewed data. Preferably, the resulting feature vectors will be sparse.

The skilled person will be aware that different approaches to the keyword search are possible, searching for single words or multiple words listed by the AND or OR operator. Moreover, the results of an image search may be refined by selecting from among a list of matches the perceived best matches and using these matches as query items for a new Bayesian Sets search. As users search the images of a database, unlabelled images could be automatically labelled by associating highly scoring images with the search keywords.

It will be understood that measures of similarity derived by algorithms other than Bayesian sets may also be used in conjunction with the image searching technique described above. Further, other features of images can also be used, for example features resulting from the filter responses of SIFT filters; see David G. Lowe, “Distinctive image features from scale-invariant keypoints,” International Journal of Computer Vision, 60, 2 (2004), pp. 91-110. and “Method and apparatus for identifying scale invariant features in an image and use of same for locating an object in an image”, David G. Lowe, U.S. Pat. No. 6,711,293, both herewith incorporated herein by reference. The Bayesian Sets method is not constrained to use any particular set of features. The image retrieval algorithm described above is also described in K. A. Heller and Z. Ghahramani (2006) “A Simple Bayesian Framework for Content-Based Image Retrieval”, In the IEEE Conference on Computer Vision and Pattern Recognition (CVPR 2006 herewith incorporated herein by reference). A prototype system implementing the image retrieval and image annotation methods has been implemented and placed online at www.inference.phy.cam.ac.uk/vr237/

The Bayesian Sets algorithm may also be used as the basis of a data set cleanup method as described below.

Consider a set of items D_w labelled with some particular label w. The assumption is that some of the items in this set are correctly labelled while some of the labels are spurious or noisy. Such noisy labelling is often present in real world data, for example, when looking at images returned by Google™ Images, many of them seem irrelevant to the query, similarly images on the Flickr™ system have labels associated with them, with widely varying degrees of relevance.

The goal of this method is to rank the items within D_{w} from most relevant to least relevant with respect to the label w. The fraction f of least relevant items can be removed from the set, creating a cleaned up data set (in other words removing the label from the least relevant items). The method can be understood with reference to the following MATLAB™ pseudo-code and FIG. 3. Note that as before each item is represented as a vector x comprising the features of that item.

```
let D_{w} = {x_{{lw}} ... x_{{nw}}} be the set of
items with label w.
let D_{{-iw}} = D_{w} \{ x_{{iw}} } be this
set minus item i (i.e. leave-out-item-i)
for i=1:n,  % where n is the number of items in D_w
% score each item by how well it fits in with the
% other item with that label in the same way
% as before for retrieval, by computing
% leave-out- item-i score
    score(i,w) = log [ P(x_{{iw}}, D_{{-iw}}) /
    ( P(x_{{iw}} ) P(D_{{-iw}}) ) ]
end;
% these scores are computed in exactly the same way
% as in the Bayesian Sets algorithm, thinking of
% the query as D_{{-iw}} and the item being scored
% as x_{{iw}}); see for example equation (16) for %
binary data
sort(score(:,w));
% sort all items in the set D_{w} according to score
% then remove the f*n items with the lowest score,
% leaving a cleaned up data set with (1−f)*n items
```

The idea is that the top scoring items associated with each label should be good representatives of that label. By cutting out some of the lowest scoring items (either with a threshold as above or by looking at the distribution of scores, for example cutting out or removing those items which have a score below a threshold vale) a noisy data set may be cleaned up. Like before, all operations can be implemented with sparse matrix-vector multiplications. It will be understood that this method of data set clean-up could use any other suitable method for storing similarity score between the leave-one-out sets and the left-out item.

The Bayesian Sets method may also be used for item annotation. The items may be images, but the method may equally be applied to other kinds of items. The method can be understood with reference to the following MATLAB™ pseudo-code and FIG. 4:

```
Given an item x and a set of possible
labels W={wₗ, ..., w_{K}}
for all labels w in the set W,
    let D_{w} = {x{lw} ... x{nw}} be the set of
    items with label w.
    score(x,w) = log [ P(x, D_{w}) / (P(x) P(D_{w}))]
% these scores are computed in exactly the same way
% as in the Bayesian Sets algorithm described above,
% thinking of the query as D_{w} and the item being
% scored as x; see for example equation (16)
% for binary data
% sort all words in the set W according to the score,
% then return the top scoring labels as suggested
% annotations for item x
sort (score (x,:));
```

As will be understood by the skilled person, the algorithm calculates a score for a pair of a given item x and label w using the Bayesian Sets score (described in more detail above) for the item x and the set of items D_{w} which are labeled with label w and then returns the top scoring labels as the labels to be used. It will be understood that any other suitable similarity score may also be used. A pre-determined number of labels can be returned or a cut-off value for the score may be used. The labels may be presented to a user for selection or may be applied automatically.

### Exemplary Results

By way of illustration only, the application of the Bayesian Sets algorithm to two data sets is now discussed and compared to corresponding results obtained from the Google Sets web page: the Encyclopedia dataset, consisting of the text of the articles in the Groliers Encyclopedia and the EachMovie dataset, consisting of movie ratings by users of the EachMovie service (see for example P. McJones. EachMovie collaborative filtering data set. http://research.compaq.com/SRC/eachmovie/, 1997).

The Encyclopedia dataset is 30991 articles by 15276 words, where the entries are the number of times each word appears in each document. The data was preprocessed (binarised) by column normalising each word and then thresholding so that a (article,word) entry is 1 if that word has a frequency of more than twice the article mean. The hyperparameters are set as described above with α=c×m, and β=c×(1−m) where m is a mean vector over all articles, and c=2. The same prior is used for both datasets.

The EachMovie dataset was preprocessed, first by removing movies rated by less than 15 people, and people who rated less than 200 movies. Then the dataset was binarized so that a (person, movie) entry had value 1 if the person gave the movie a rating above 3 stars (from possible ratings of 0-5 stars). The data was then column normalized to account for overall movie popularity. The size of the dataset after preprocessing was 1813 people by 1532 movies.

The results of these experiments and comparisons with Google Sets for word and movie queries are given in tables 2 and 3. The running times of the Bayesian Sets algorithm on all three datasets are given in table 1. All experiments were run in Matlab™ on a 2 GHz Pentium 4, Toshiba laptop.

TABLE 1
The size of the datasets along with the time taken to do the (one-time)
preprocessing and the time taken to make a query (both in seconds).

| | ENCYCLOPEDIA | EACHMOVIE |
|---|---|---|
| SIZE | 30991 × 15276 | 1813 × 1532 |
| NON-ZERO ELEMENTS | 2,363,514 | 517,709 |
| PREPROCESS TIME | 6.1 S | 0.56 S |
| QUERY TIME | 1.1 S | 0.34 S |

TABLE 2
Clusters of words found by Google Sets and Bayesian Sets based on the given
queries. The top 11 are shown for each query and each algorithm.
Bayesian Sets was run using Encyclopedia data.

| Query: Warrior, Soldier | | Query: Animal | | Query: Fish, Water, Coral | |
|---|---|---|---|---|---|
| Google Sets | Bayes Sets | Google Sets | Bayes Sets | Google Sets | Bayes Sets |
| warrior | Soldier | animal | Animal | fish | water |
| soldier | warrior | plant | animals | water | fish |
| spy | mercenary | free | plant | coral | surface |
| engineer | Cavalry | legal | humans | agriculture | species |
| medic | brigade | fungal | food | forest | waters |
| sniper | commanding | human | species | rice | marine |
| Demoman | samurai | hysteria | mammals | silk road | food |
| pyro | brigadier | vegetable | ago | religion | Temperature |
| scout | infantry | mineral | organisms | history politics | ocean |
| pyromaniac | colonel | indeterminate | vegetation | desert | shallow |
| hwguy | shogunate | fozzie bear | plants | arts | ft |

TABLE 3
a. Clusters of movies found by Google Sets and Bayesian Sets based on the given
queries. The top 10 are shown for each query and each algorithm. Bayesian Sets was run
using the EachMovie dataset.
Query: Gone with the wind, casablanca

| Google Sets | Bayes Sets |
|---|---|
| casablanca (1942) | gone with the wind (1939) |
| gone with the wind (1939) | casablanca (1942) |
| ernest saves christmas (1988) | the african queen (1951) |
| citizen kane (1941) | the philadelphia story (1940) |
| pet detective (1994) | my fair lady (1964) |
| vacation (1983) | the adventures of robin hood (1938) |
| wizard of oz (1939) | the maltese falcon (1941) |
| the godfather (1972) | rebecca (1940) |
| lawrence of arabia (1962) | singing in the rain (1952) |
| on the waterfront (1954) | it happened one night (1934) |

b. Clusters of movies found by Google Sets and Bayesian Sets based on the given
queries. The top 10 are shown for each query and each algorithm. Bayesian Sets was run
using the EachMovie dataset.

| | | Query: Cutthroat Island, | |
|---|---|---|---|
| Query: Mary Poppins, Toy Story | | Last Action Hero | |
| Google Sets | Bayes Sets | Google Sets | Bayes Sets |
| toy story | mary poppins | last action hero | cutthroat island |
| mary poppins | toy story | cutthroat island | last action hero |
| toy story 2 | winnie the pooh | girl | kull the conqueror |
| moulin rouge | cinderella | end of days | vampire in brooklyn |
| the fast and the furious | the love bug | hook | sprung |
| presque rien | bedknobs and | the color of night | judge dredd |
| | broomsticks | | |
| spaced | davy crockett | coneheads | wild bill |
| but i'm a cheerleader | The parent trap | addams family I | highlander III |
| mulan | dumbo | addams family II | village of the damned |
| who framed roger rabbit | the sound of music | singles | fair game |

It should be noted that it is very difficult to objectively evaluate these results since this is a task for which there is no ground truth. One person's idea of a good query cluster may differ drastically from another person's. Google Sets performed very well when the query consisted of items which can be found listed on the web (e.g. Cambridge colleges). On the other hand, for more abstract concepts (e.g. “soldier” and “warrior”, see Table 2) the Bayesian Sets algorithm returned apparently more sensible completions.

These results were evaluated in the following way: thirty naïve subjects were shown unlabelled results of the Bayesian sets and Google Sets algorithms in randomized order and asked to choose which they feel is a better set completion, for the six queries in tables 2 and 3. Averaging over the six queries about 90 percent preferred Bayesian Sets to Google Sets; one sided Binomial tests rejected the hypothesis that Google Sets were better (p<0.001) in all six cases.

### Exponential Families

The Bayesian sets algorithm can also be applied to models in the exponential family. The distribution for such models can be written in the form

p(x|θ)=ƒ(x)g(θ)exp{θ^{τ}u(x)} (17)

where u(x) is a K-dimensional vector of sufficient statistics, θ are natural parameters, and ƒ and g are non-negative functions. The conjugate prior is

p(θ|η,ν)=h(η,ν)g(θ)^{η} exp{θ^{τ}ν} (18)

where η and ν are hyperparameters, and h normalizes the distribution. Given a query D_{c}={xᵢ} with N items, and a candidate x, it is not hard to show that the score for the candidate is:

$$score ( x ) = \frac{h ( η + 1 , v + u ( x ) ) h ( η + N , v + {\sum }_{i} u ( {x}_{i} ) )}{h ( η , v ) h ( η + N + 1 , v + u ( x ) + {\sum }_{i} u ( {x}_{i} ) )} \qquad ( 19 )$$

This expression allows to understand when the score can be computed efficiently. First of all, the score only depends on the size of the query (N), the sufficient statistics computed from each candidate, and from the whole query. It therefore makes sense to precompute U, an M×K dimensional matrix of sufficient statistics corresponding to X where M is the number of items or rows of X. Second, whether the score is a linear operation on U depends on whether log h is linear in the second argument. This is the case for the Bernoulli and discrete distributions, but not for all exponential family distributions. However, for many distributions, such as diagonal covariance Gaussians, even though the score is nonlinear in U, it can be computed by applying the nonlinearity elementwise to U. For sparse matrices, the score can therefore still be computed in time linear in the number of non-zero elements of

### CONCLUSION

The above embodiments described algorithms which take a query consisting of a small set of items and return additional items which are likely to belong to the same set in the sense that they are likely to have been generated from the same generating distributions. The output of the algorithm can be a sorted list of items or simply a score which measures how likely the items are to belong to the same set. In the former case, a fixed number of items may be returned or a threshold for the log probabilities of items which are returned may be set. In order to interpret the score as a log probability which can be compared between queries, the score may be calculated including the term c in equation 13. Additionally, it would be apparent to the skilled person that other, dynamic schemes for determining the number of items to be returned by the algorithm can also be implemented.

It will be evident to the skilled person that the algorithms described above are applicable to a wide range of data sets and can be implemented on any suitable computing program using any suitable programming language. The algorithms may be implemented on a stand alone or networked computer and may be distributed across a network, for example between a client and a server. In the latter case, the server could perform all essential computations while the client provides only an interface with the user or the computations may be distributed between the clients and the server.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software.

Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment, of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the scope of the claimed subject matter.

1. A computer-implemented method of scoring similarity between one or more query items and one or more other items, each of the items being represented by a feature vector xᵢ comprising a plurality of digitally represented features xᵢⱼ, the method including:
a) receiving an input identifying the query items;
b) for each of the other items computing a score which is a function of a conditional probability of the feature vectors xᵢ of the query items being generated from a generating distribution p(xᵢ|θ defined by parameters θ given that the feature vector xᵢ of the respective other item is generated from the generating distribution p(xᵢ|θ; and
c) returning a score for each of the other items, a list of some or all of the other items sorted by their respective score or a list of n other items which have the highest score.

2. A method as claimed in claim 1 in which the function has the effect of averaging over all possible values of the parameters θ, weighted by a probability distribution p(θ) over parameter values.

3. A method as claimed in claim 2, in which the feature vectors xᵢ are binary vectors, the generating distribution is a product of Bernoulli distributions, the product includes a Bernoulli distribution for each feature xᵢⱼ and the probability distribution p(θ) over parameter values is a Beta distribution p(θ|α,β) with parameters α and β.

4. A method as claimed in claim 3 in which the function includes a product of a matrix X containing the feature vectors xᵢ of the other items and a vector q the elements of which are given by qⱼ=log \tilde{α}ⱼ−log αⱼ−log \tilde{β}ⱼ+log βⱼ whereby αⱼ and βⱼ are parameters of the Beta distribution \tilde{α}ⱼ=αⱼ+Σₖ₌₁^{N} xₖⱼ and \tilde{β}ⱼ=βⱼ+N−Σₖ₌₁^{N} xₖⱼ, N is the number of items in the query and the sums are over query items.

5. A computer implemented method of scoring the similarity between N query items and one or more other items, each of the items being represented by a feature vector xᵢ comprising a plurality of binary features xᵢⱼ, the method including:
a) receiving an input identifying the query items
b) defining a vector q for the query, the elements of q being defined by qⱼ=log \tilde{α}ⱼ−log αⱼ−log \tilde{β}ⱼ+log βⱼ whereby αⱼ and βⱼ are parameters, \tilde{α}ⱼ=αⱼ+Σₖ₌₁^{N} xₖⱼ, \tilde{β}ⱼ=βⱼ+N−Σₖ₌₁_{N} xₖⱼ, and the sum is over the query items
c) calculating a score as a function of a product of a matrix X and q, whereby X is a matrix containing all feature vectors xᵢ of the other items
d) returning a score for each of the other items a list of some or all of the other items sorted by their respective score, or a list of n other items which have the highest score.

6. A method as claimed in claim 4, including using sparse matrix multiplication methods for calculating the product of X and q.

7. A method as claimed in claim 4 including pre-processing the items such that only those other items xᵢ which have at least a predefined number of features xᵢⱼ in common with the query items are scored.

8. A method as claimed in claim 4 the function including adding
$$c = {\sum }_{j} log ( {α}_{j} + {β}_{j} ) - log ( {α}_{j} + {β}_{j} + N ) + log {\tilde{β}}_{j} - log {β}_{j}$$
to the score to make it comparable between queries.

9. A method as claimed in claim 4 in which αⱼ=const·mⱼ and βⱼ=const·(1−mⱼ), whereby const is a constant and mⱼ is the average of xᵢⱼ over all or some of the items.

10. A method as claimed in claim 1 in which receiving an input identifying the query items includes:
i) responsive to a user input of search criteria, searching a database to return one or more hits;
ii) receiving a user selection of items among the hits;
iii) using the selection to define the query items; and
wherein the method includes returning a list of M other items which have the highest score.

11. A method as claimed in claim 1 in which the items are images and receiving an input identifying the query items includes, responsive to a user input of search criteria, identifying one or more images associated with a searchable label which matches the search criteria and identifying the identified images as query items.

12. A method as claimed in claim 1 in which the feature vectors are representative of one of the group of web pages, images, patient records, gene sequences, proteins, pharmaceutical molecules, movies, music pieces, goods, people, investment instruments, companies, patents and words.

13. A method as claimed in claim 1 including presenting a completed set of items similar to the query items to a user.

14. A method of cleaning up a data set of items labelled with a particular label including:
for each item of the data set calculating a clean-up score using a method as claimed in claim 1 wherein the query items are all items in the data set leaving out the item to be scored and the other item is the item to be scored; and
removing items based on the respective clean-up scores, thereby cleaning up the data set.

15. A method as claimed in claim 14 including removing a predetermined number of items having the lowest scores or all items with a score less than a threshold value.

16. A method of annotating an item including calculating an annotation score for each of a set of labels using a method as claimed in claim 1 wherein the query items are items labelled with the label to be scored, the other item is the item to be annotated and the annotation score is the returned score for the other item;
selecting one or more labels to be applied to the item to be annotated based on the respective annotation scores.

17. A method as claimed in claim 16 in which a predetermined number of items having the highest annotation score is selected or in which items having an annotation score greater than a threshold are selected.

18. A method as claimed in claim 1 in which the feature vectors are derived from real-valued feature vectors by thresholding the values of the features such that the resulting feature vectors are sparse.

19. A method as claimed in claims 1 in which the generating distribution is a member of the exponential family of distributions.

20. A method as claimed in claim 19 in which the generating distribution is a Gaussian having a diagonal covariance matrix.

21. A computer system arranged to implement a method as claimed in claim 1.

22. A computer program product comprising computer code instructions adapted to implement a method as claimed in claim 1.

23. A computer readable medium carrying a computer program product as claimed in claim 22.

24. A data signal carrying a computer program product as claimed in claim 22

25. A computer implemented method of searching a data base of images including:
responsive to a user input of search criteria, searching a data base of labelled images to return one or more images having at least one label matching the query;
receiving a user selection of images among the returned images;
calculating a similarity score between the selected images and unlabelled images in the data base; and
returning a set of unlabelled images based on their respective scores.

26. A computer implemented method of cleaning up a data set of items labelled with a particular label including:
for each item of the data set calculating a clean up score which is a measure of the similarity between all the items in the data set leaving out the item to be scored and the item to be scored; and
removing items based on the respective clean ups scores, thereby cleaning up the data set.

27. A computer implemented method of annotating an item including:
calculating an annotation score for each of a set of labels as a measure of similarity between items labelled with the label to be scored and the item to be annotated; and
selecting one or more labels to be applied to the item to be annotated based on the respective annotation scores.
